(19) United States
(12) Patent Application Publication
(10) Pub. No.: US 2018/0108097 A1
(43) Pub. Date: Apr. 19, 2018

(54) Method of Measuring and Provision of Lumens

(71) Applicant: Federal Law Enforement Development Services, Inc., St. Cloud, MN (US)

(72) Inventor: John C. Pederson, Merritt Island, FL (US)

(73) Assignee: Federal Law Enforement Development Services, Inc., St. Cloud, MN (US)

(21) Appl. No.: 15/835,000

(22) Filed: Dec. 7, 2017

Related U.S. Application Data
(63) Continuation of application No. 14/207,934, filed on Mar. 13, 2014.
(60) Provisional application No. 61/778,672, filed on Mar. 13, 2013.

(51) Int. Cl. G06Q 50/06; G06Q 30/04; G06Q 30/02; G06Q 20/10; G06Q 20/14

(52) U.S. Cl. CPC G06Q 50/06; G06Q 30/04; G06Q 30/0207; G06Q 20/145; G06Q 20/102

(57) ABSTRACT

Techniques are disclosed for compensating an LED light fixture/light source provider for generation of photons and data communications by one or more LED light fixtures used by a customer. The relationship including a requirement that the provider pay an electricity supplier for the electricity consumed by the LED light fixtures/light sources, determining, with the amount of electricity consumed by the LED light fixtures/light sources used by the customer over a period of time, and in response to the determination and on behalf of the customer, submitting payment to the customer's electricity supplier for the electricity consumed by the LED light fixtures/light sources used by the customer. The customer compensating the provider an agreed amount for use of each LED light fixture.

### CROSS-REFERENCE TO RELATED APPLICATIONS

This application is a Continuation of U.S. patent application Ser. No. 14/207,934, filed on Mar. 13, 2014, which claims the benefit of U.S. Provisional Application Ser. No. 61/778,672, filed on Mar. 13, 2013, which is a Continuation-in-Part of U.S. patent application Ser. No. 13/972,294, filed on Aug. 21, 2013, which is a Continuation of U.S. patent application Ser. No. 13/350,463, filed on Jan. 13, 2012, patented as U.S. Pat. No. 8,543,505, which claims the benefit of U.S. Provisional Application No. 61/432,949, filed on Jan. 14, 2011, the entire contents all of which are incorporated herein by reference. U.S. patent application Ser. No. 14/207,934, filed on Mar. 13, 2014, also claims the benefit of U.S. Provisional Application Ser. No. 61/927,638, filed on Jan. 15, 2014 the entire content of which is incorporated herein by reference.

### TECHNICAL FIELD

The disclosure relates to light emitting diodes (LEDs) and, more particularly, to managing the costs associated with LED lighting fixtures.

### BACKGROUND

Present communication techniques using radiofrequency (RF) suffer from a number of problems. First, there are security concerns because transmissions using RF can be easily intercepted, in part because of the fact that RF signals are designed to radiate signals in all directions. Second, the heavy regulation by the Federal Communications Commission (FCC) and its control of the frequencies that may be used for RF transmission often present daunting challenges to RF broadcasters. Third, RF by its very nature is susceptible to interference and produces noise.

In contrast to RF communications, light sources used for communication are extremely secure due to the fact that they are focused within a narrow beam, requiring placing equipment within the beam itself for interception. Also, because the visible spectrum is not regulated by the FCC, light sources can be used for communications purposes without the need of a license. Further, light sources are not susceptible to interference nor do they produce noise that can interfere with other devices.

Light emitting diodes (LEDs) can be used as light sources for data transmission, as described in U.S. Pat. Nos. 6,879,263 and 7,046,160, the entire contents of each being expressly incorporated herein by reference. LEDs have quick response to “ON” and “OFF” signals, as compared to the longer warm-up and response times associated with fluorescent lighting, for example. LEDs are also efficient in producing light, as measured in lumens per watt. Recent developments in LED technology, such as high brightness blue LEDs, which in turn paved the way for white LEDs, have made LEDs a practical alternative to conventional light sources. As such, LED technology provides a practical opportunity to combine lighting and communication. This combination of lighting and communication allows ubiquitous light sources such as street lights, home lighting, and office building lighting, for example, to be converted to, or supplemented with, LED technology to provide for communications while simultaneously producing light for illumination purposes.

Regarding office buildings, building management is a complex science which incorporates and governs all facets of human, mechanical and structural systems associated with buildings. As a result of the complexity, most commercial buildings are managed by commercial property management companies with great expertise. Both at the time of construction and throughout the life-cycle of a building, the interrelationships between individuals and the mechanical and structural systems are most desirably evaluated. Where possible and cost-effective, human interactions with a building and associated mechanical systems will be optimized, in turn providing the greatest benefit to both the owners and those who use the facilities afforded by the building. Noteworthy is the fact that building users may include both regular occupants such as individual or commercial tenants, and also transient occupants such as visitors, guests, or commercial customers.

Building management includes diverse facets, some which are simply representations of the building and associated systems and people, and other facets which are tangible. Exemplary of representations are accounting or financial monitoring responsibilities which will including record keeping control and assurance of financial transactions involving tenants, owners, and service providers. Exemplary of the physical or tangible responsibilities are physical development and maintenance, including identification of need for features, improvements, maintenance and the assurance of the execution of the same. As is well understood by those highly versed in building management, the diverse responsibilities and extent of information required to manage a building is often quite overwhelming.

One very important area associated with building management is lighting or illumination. While often perceived as a simple task of providing lights, this seemingly simple task has much research and science behind a well-designed lighting system. This is because safety, productivity and general well-being of occupants depend heavily on proper lighting.

Many factors need to be considered at the time of construction or remodeling to facilitate proper lighting design. Intended usage of a space is important in illumination design considerations, since this will dictate necessary illumination levels, times and duration of use, and anticipated cycling of the illumination. In other words, a supply closet will not ordinarily be designed for around-the-clock illumination, and may instead by configured to operate on a switch, or alternatively a motion detector with relatively short-delay turn-off when no motion is detected. The use of appropriate switches and motion detectors helps to reduce the energy required for a building to function with occupants, and simultaneously increases the life of many illumination components such as light sources (light bulbs and equivalents thereto) since the light sources are only required intermittently. As another example, a room where movies, slides, computer or other visual or audio-visual presentations are given, such as a boardroom or classroom, will preferably have light controls such as separate switches or combinations of switches and dimmer controls, which enable the entire room to be well lit or alternatively maintain a minimum level of illumination normally opposite to where the presentation is displayed. This minimum level of illumination enables occupants sufficient light for note-taking, safe movement and other important activities, without interfering with the legibility of a presentation. In yet another example, a primary work-space such as a desk or kitchen counter will require illumination that does not cast shadows on the work space while work is being performed. Complementary illumination, such as windows or skylights, is also important in design consideration.

Nearly all public buildings rely on a great many lamps positioned throughout the interior of the building, such as along hall corridors and in each room, and also about the exterior. These lights have historically been activated manually, though more recently, a small but growing number are activated according to occupancy, proximity or motion sensors, typically incorporating the well-known Infra-Red (IR) motion sensors. Architects are commonly employed to assist not only with a floor plan of physical spaces, but also with the proper selection and layout of lighting to best complement the floor plan and usage of each space within a building. As may be appreciated, illumination of a space is determined at the time of production of blueprints, in anticipation of construction. The illumination that has been chosen for a space is essentially fixed during building construction. Changes may be made later, but not without substantial additional expense that will, for exemplary purposes, often include removal of parts of or entire walls, with the accompanying disruption of the space. Often the space is unavailable for use during the entire duration of a remodeling project.

Further complicating the issue of illumination is the type of light bulb that may be most appropriate for a space or location. Original electric light bulbs were incandescent. With sufficient electrical energy, which is converted to heat within an incandescent bulb filament, the filament will emit visible light. This is similar to a fire, where with enough heat, visible light is produced. As might also be appreciated though, incandescent bulbs produce far more heat than light. The color of the light from these bulbs is also most commonly quite yellow, casting a warm hue at a color temperature typically in the vicinity of 3,000 degrees Kelvin. Warm hues are often prized in relaxed settings such as those of a living room or dining room, more closely resembling gentle candle light. However, in contrast thereto, work and study environments are more preferably illuminated with light of more blue content, more closely resembling daylight with color temperatures of approximately 6,000 degrees Kelvin. Daylight color temperatures are not practically obtained using an incandescent bulb. In addition, these incandescent bulbs have only a few thousand hour life expectancy, even with more than a century of improvements, because the extreme temperatures required for the filament to light also gradually evaporates the filament material. Finally, the thermal mass of the filament greatly influences how quickly the filament both illuminates and extinguishes. In spite of the many limitations, incandescent bulbs are still in fairly widespread use today.

An alternative to incandescent light bulbs in common use today is the fluorescent bulb. A fluorescent light bulb uses a small amount of mercury in vapor state. High voltage electricity is applied to the mercury gas, causing the gas to ionize and generate some visible light, but primarily Ultraviolet (UV) light. UV light is harmful to humans, being the component that causes sun burns, so the UV component of the light must be converted into visible light. The inside of a fluorescent tube is coated with a phosphorescent material, which when exposed to ultraviolet light glows in the visible spectrum. This is similar to many glow-in-the-dark toys and other devices that incorporate phosphorescent materials. As a result, the illumination from a fluorescent light will continue for a significant time, even after electrical power is discontinued, which for the purposes of the present disclosure will be understood to be the latent period or latency between the change in power status and response by the phosphor. As the efficiencies and brightness of the phosphors has improved, so in many instances have the delays in illumination and extinguishing, or latency, increased. Through the selection of many different modern phosphorescent coatings at the time of manufacture, fluorescent bulbs may be manufactured that produce light from different parts of the spectrum, resulting in manufacturing control of the color temperature, or hue or warmness of a bulb.

The use of fluorescent bulbs, even though quite widespread, is controversial for several reasons. One source states that all pre-1979 light ballasts emit highly toxic Polychlorinated BiPhenyls (PCBs). Even if modern ballasts are used, fluorescent bulbs also contain a small but finite amount of mercury. Even very small amounts of mercury are sufficient to contaminate a property. Consequently, both the manufacture and disposal of mercury-containing fluorescent tubes is hazardous. Fluorescent lighting has also been alleged to cause chemical reactions in the brain and body that produce fatigue, depression, immuno-suppression, and reduced metabolism. Further, while the phosphor materials may be selected to provide hue or color control, this hue is fixed at the time of manufacture, and so is not easily changed to meet changing or differing needs for a given building space.

Other gaseous discharge bulbs such as halide, mercury or sodium vapor lamps have also been devised. Halide, mercury and sodium vapor lamps operate at higher temperatures and pressures, and so present undesirably greater fire hazards. In addition, these bulbs present a possibility of exposure to harmful radiation from ruptured outer bulbs that go undetected. Furthermore, mercury and sodium vapor lamps generally have very poor color-rendition-indices, meaning the light rendered by these bulbs is quite different from ordinary daylight, distorting human color perception. Yet another set of disadvantages has to do with the starting or lighting of these types of bulbs. Mercury and sodium vapor lamps both exhibit extremely slow starting times, often measured by many minutes. The in-rush currents during starting are also commonly large. Many of the prior art bulbs additionally produce significant and detrimental noise pollution, commonly in the form of a hum or buzz at the frequency of the power line alternating current. In some cases, such as fluorescent lights, ballasts change dimension due to magnetostrictive forces. Magnetic field leakage from the ballast may undesirably couple to adjacent conductive or ferromagnetic materials, resulting in magnetic forces as well. Both types of forces will generate undesirable sound. Additionally, in some cases a less-optimal bulb may also produce a buzzing sound.

When common light bulbs are incorporated into public and private facilities, the limitations of existing bulb technologies often will adversely impact building occupants. As just one example, in one school the use of full-spectrum lamps in eight experimental classrooms decreased anxiety, depression, and inattention in students with SAD (Seasonal Affective Disorder). The connection between lighting and learning has been conclusively established by numerous additional studies. Mark Schneider, with the National Clearinghouse for Educational Facilities, declares that ability to perform requires “clean air, good light, and a quiet, comfortable, and safe learning environment.” Unfortunately, the flaws in much of the existing lighting have been made worse as buildings have become bigger. The foregoing references to schools will be understood to be generally applicable to commercial and manufacturing environments as well, making even the selection of types of lights and color-rendition-indexes very important, again depending upon the intended use for a space. Once again, this selection will be fixed, either at the time of construction when a particular lighting fixture is installed, or at the time of bulb installation, either in a new fixture or with bulb replacements.

A second very important area associated with building management is energy management. The concern for energy management is driven by the expense associated with energy consumed over the life of a building. Energy management is quite challenging to design into a building, because many human variables come into play within different areas within a building structure. Considering the foregoing discussion of lighting, different occupants will have different preferences and habits. Some occupants may regularly forget to turn off lights when a space is no longer being occupied, thereby wasting electricity and diminishing the useful life of the light bulbs. In another instance, one occupant may require full illumination for that occupant to operate efficiently or safely within a space, while a second occupant might only require a small amount or local area of illumination. Further complicating the matter of energy management is the fact that many commercial establishments may have rates based upon peak usage. A business with a large number of lights that are controlled with a common switch may have peak demands which are large relative to total consumption of power, simply due to the relatively large amount of power that will rush in to the circuit. Breaking the circuit into several switches may not adequately address inrush current, since a user may switch more than one switch at a time, such as by sliding a hand across several switches at once. Additionally, during momentary or short-term power outages, the start-up of electrical devices by the power company is known to cause many problems, sometimes harming either customer equipment or power company devices. Control over inrush current is therefore very desirable, but not economically viable in the prior art.

Energy management also includes consideration for differences in temperature preferred by different occupants or for different activities. For exemplary purposes, an occupant of a first office space within a building may prefer a temperature close to 68 degrees Fahrenheit, while a different occupant in a second office space may prefer a temperature close to 78 degrees Fahrenheit. The first and second office spaces may even be the same office space, just at different times of day. For exemplary purposes, an employee working in a mail room from 8 a.m. until 4 p.m. may be replaced by a different mail room employee who works from 4 p.m. until 12 a.m. Heating, Ventilation, and Air Conditioning (HVAC) demand or need is dependent not only upon the desired temperature for a particular occupant, but also upon the number of occupants within a relatively limited space. In other words, a small room with many people will require more ventilation and less heating than that same room with only one occupant.

With careful facility design, considerable electrical and thermal energy can be saved. Proper management of electrical resources affects every industry, including both tenants and building owners. In the prior art, this facility design has been limited to selection of very simple or basic switches, motion detectors, and thermostats, and particular lights, all fixed at the time of design, construction or installation.

A third very important area associated with building management is security. Referring to a school as but one example of a public building, a one-room country school fifty years ago was made up of one teacher who knew well the small number of pupils. Security consisted of a simple padlock on a wooden door. The several windows on one side of the room provided light. They were locked but almost never broken into, for nothing of major value, even during the Depression, enticed potential thieves.

Architecture changed as the years passed. Buildings were enlarged as school populations increased. Students started to conceal books, outerwear, valuables, and occasionally even weapons in enclosed lockers. Indoor lighting was required. Eventually as society became more hazardous, security was required in many schools in the form of personnel who both patrolled the outside and inside of the school in order to provide a measure of safety.

In many public buildings, including schools, modern security presently screens a building's occupants to ensure that they belong or have proper authorization to enter the building. Security must also check for weapons, drugs, and even explosives. Thus, modern security personnel are often responsible for property as well as people. As the types of potential perils increase, so does the need for personnel, to process occupants through more and more stations. For exemplary purposes, in schools, airports, court houses, and other public facilities, one or more guards may check identification, admission badges or paperwork, while one or more other guards monitor metal detectors. One or more additional guards may be monitoring drug sniffing dogs or equipment, or spot checking bags. Unfortunately, the possibilities of duplication and/or forgery of credentials, or security infiltration, or other criminal methods demonstrate the potential weaknesses of the present system, which depends upon a large number of security employees. Motion sensors and other prior art electronic security measures, while often beneficial, occasionally fail even when used in combination with security personnel to provide adequate protection. On the outside of a building, motion sensors may be activated by strong winds, stray animals, passing vehicles, or blowing debris. Inside, they operate only for a specific time; a room's occupant, if not moving about, may suddenly be in the dark and must re-activate the light by waving or flailing about.

An increasingly complex, and therefore hazardous, society requires increasingly extensive patrols and safeguards. Current security system, which must rely on increasing the numbers of guards and security devices, are subject to inherent defects and extraordinary expense, generally rendering them inadequate even with the best of intention.

Yet another very important area associated with building management is guidance control and indication, which impacts building security, as well as building convenience and efficiency for occupants. In buildings having many alternative hallways or paths, such as are commonly found in hospitals and other large public facilities, directions are often clumsy and difficult for visitors or emergency personnel to follow. Old-fashioned directories may be hard to locate or decipher, especially speakers of a foreign language or for persons with little or no time, again such as emergency personnel. Consequently, some buildings provide color stripes along walls that serve as color coding to guide visitors to various areas within the building. Unfortunately, the number of color stripes that may be patterned is quite limited, and the expense and defacing of appearance associated therewith is undesirable. Furthermore, such striping does not completely alleviate confusion, and the color stripes can only serve as general guides to commonly visited areas.

In addition to their numerous uses with building management, LEDs are beginning to be considered for use in networking applications. In any network, a variety of client devices may communicate with one or more host devices. The host may provide connection to a Local Area Network (LAN), sometimes referred to as an Intranet, owing to the common use of such a network entirely within an office space, building, or business. The host may additionally or alternatively provide connection to a Wide Area Network (WAN), commonly describing a network coupling widely separated physical locations which are connected together through any suitable connection, including for exemplary purposes but not solely limited thereto such means as fiber optic links, T1 lines, Radio Frequency (RF) links including cellular telecommunications links, satellite connections, DSL connections, or even Internet connections. Generally, where more public means such as the Internet are used, secured access will commonly separate the WAN from general Internet traffic. The host may further provide access to the Internet.

A variety of client devices have been considered for connection to host devices. Such client devices may commonly include computing devices of all sorts, ranging from hand-held devices such as Personal Digital Assistants (PDAs) to massive mainframe computers, and including Personal Computers (PCs). However, over time many more devices have been considered for connection to network hosts, including for exemplary purposes printers, network storage devices, cameras, other security and safety devices, appliances, HVAC systems, manufacturing machinery, and so forth. Essentially, any device which incorporates or may be made to incorporate sufficient electronic circuitry may be considered for linking to a host.

Existing client devices are designed to connect to host network access points through wired connections, like copper wire, for example, fiber optic connections, or as wireless connections, such as wireless routers. In the case of a wired system, whether through simple wire, twisted wire, co-axial cable, fiber optics or other line or link, the host and client are tethered together through this physical communications channel. The tether, as may be appreciated, limits movement of the client relative to the host, is often unsightly and hard to contain in a workspace, and so may even be or become a tripping hazard. In addition, electrical connectors such as jacks must be provided, and these connectors necessarily limit the number of access points and locations. The installation of connectors defaces walls, sometimes rendering them unsuitable for a particular desired application, and yet they add undesirable installation expense, whether during new construction or in retrofitting an existing building structure.

In contrast, in the case of wireless routers, an RF signal replaces the physical communications channel with a radio channel. This advantageously eliminates the wire or fiber tether between client and host. Instead, client devices in a wireless system try through various broadcasts and signal receptions to find an access point that will have adequate transmission and reception, generally within a certain signal range which may range from a few meters to as many as several tens of meters. The systems are programmed to bridge from a host access point to various client devices through known exchanges of information, commonly described as communications protocols or handshakes. Depending upon the communications channel, a variety of client connection devices are utilized such as PCMCIA or PC cards, serial ports, parallel ports, SIMM cards, USB connectors, Ethernet cards or connectors, FireWire interfaces, Bluetooth compatible devices, infrared/IrDA devices, and other known or similar components.

The security of these prior art wireless devices may be compromised in that they are vulnerable to unauthorized access or interception, and the interception may be from a significant distance, extending often well beyond physical building and property boundaries.

Moreover, reliability may be hindered by interference from an appliance such as a microwave oven.

Buildings may encompass a very large number of rooms or discrete spaces, each functioning relatively independently from each other. Where the rooms or discrete spaces together form a larger entity such as a business, public institution or facility, or the like, which have attempted to include synchronized time keeping throughout the entity. A large number of buildings, both public and private, have synchronized clocks installed therein.

These same buildings also have a number of additional features including, for exemplary purposes though not limited thereto, fire and smoke detection, temperature control, and public address. Because of the ever-changing nature of a building and the best practices associated therewith, it can be quite difficult if not impossible to keep all areas within a building up to date with best practices or preferred capabilities. One method of desirable features or capabilities within a building space is through the use of electrical wiring adequate to accommodate the features or capabilities, particularly when the features or capabilities are identified subsequent to original construction.

Furthermore, other factors, such as weather conditions and sunlight or lack thereof through windows in a room may have as much or greater effect on the need for HVAC control. However, many older buildings were only provided with a single central thermostat, providing the same amount of heating or air conditioning to a room or other space regardless of demand for the same. Newer HVAC systems enable control, through electrically controlled dampers or vents within the HVAC system to much more precisely respond to the needs of a single space or room within a building. However, without providing wiring within the room to accommodate the thermostat and various duct controls, the room may not be individually controlled.

Even where a building is originally provided with appropriate wiring for each electrical system or component desired, necessary remodeling may critically alter the need. As one example, consider when a room or space is subdivided into two smaller spaces. Existing wiring only provides for electrical connection to one set of devices for one room. In this case, it may be necessary to run new wires back to one or more central locations, utility rooms, or the like to accommodate the new room and devices within the room.

More buildings are incorporating wireless networks within the building, the networks which are intended to reduce the need for wiring alterations and additions practiced heretofore. However, these wireless networks are not contained within the walls of a building, and so they are subject to a number of limitations. One of these is the lack of specific localization of a signal and device. For exemplary purposes, even a weak Radio-Frequency (RF) transceiver, in order to communicate reliably with all devices within a room, will have a signal pattern that will undoubtedly cross into adjacent rooms. If only one room or space in a building is to be covered, this signal overlap is without consequence. However, when many rooms are to be covered by different transceivers, signal overlap between transceivers requires more complex communications systems, including incorporating techniques such as access control and device selection based upon identification. Since the radio signal is invisible, detection of radiant pattern and signal strength are difficult and require special instruments. Further, detection of interference is quite difficult. Finally, such systems are subject to outside tapping and corruption, since containment of the signal is practically impossible for most buildings.

Another issue associated with use of conventional and LED lighting sources concerns the difficulty in quantifying the amount of use of a light source, as well as the amount of degradation or exhaustion of a light source before light source failure.

All U.S. patents and applications and all other published documents mentioned anywhere in this application are incorporated herein by reference in their entirety.

### GENERAL DESCRIPTION OF THE INVENTION

In general, this disclosure describes techniques for compensating an LED light fixture provider for generation of photons by one or more LED light fixtures used by a customer. More particularly, in accordance with various techniques of this disclosure, an LED light fixture provider receives compensation from customers using the provider's LED light fixtures, and the provider pays the customer's electricity supplier, on behalf of the customer, a monetary amount for the cost of the electricity used to generate the photons by each LED light fixture on the customer's premises. In this manner, the LED light fixture provider has inserted itself between the customer and the electricity supplier, e.g., a power company, in order to generate a revenue stream for the provider.

In one example, this disclosure is directed to a method of compensating an LED light fixture provider for generation of photons by one or more LED light fixtures used by a customer. The method comprises receiving a pre-determined monetary amount as compensation for photons generated by the LED light fixtures, maintaining a contractual relationship with the customer for a period of time in exchange for the pre-determined monetary amount, the contractual relationship including a requirement that the provider pay the customer's electricity supplier for the electricity consumed by the LED light fixtures used by the customer, determining, with a meter associated with each respective LED light fixture, the amount of electricity consumed by the LED light fixtures used by the customer over a period of time, in response to the determination and on behalf of the customer, submitting payment to the customer's electricity supplier for the electricity consumed by the LED light fixtures used by the customer.

In another example, this disclosure is directed to a method of compensating an LED light source provider for generation of photons from at least one LED light source used by a customer. The method comprises receiving a pre-determined monetary amount as compensation for photons generated by the at least one LED light source, maintaining a contractual relationship with the customer for a period of time in exchange for the pre-determined monetary amount, the contractual relationship including a requirement that the provider pay the customer's electricity supplier for the electricity used to generate the photons by the at least one LED light source, determining, with a meter associated with each respective LED light source, the amount of photons generated by the at least one LED light source over a period of time, and in response to the determination and on behalf of the customer, submitting payment to the customer's electricity supplier for the photons consumed by the at least one LED light source.

The details of one or more aspects of the disclosure are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating one example communication system that may be used with the techniques of this disclosure.

FIG. 2 is a block diagram illustrating an example LED light fixture that may be used with the techniques of this disclosure.

FIG. 3 is a block diagram illustrating an example metering configuration for an LED light fixture, in accordance with various technique of this disclosure.

FIG. 4 is a block diagram illustrating an example LED light fixture agreement between a customer and a licensor.

FIG. 5 is a flow chart illustrating an example method of compensating an LED light fixture provider for generation of photons by one or more LED light fixtures used by a customer.

FIG. 6 is a block diagram of an example system for compensating an LED light fixture provider for generation of photons by one or more LED light fixtures used by a customer.

### DETAILED DESCRIPTION

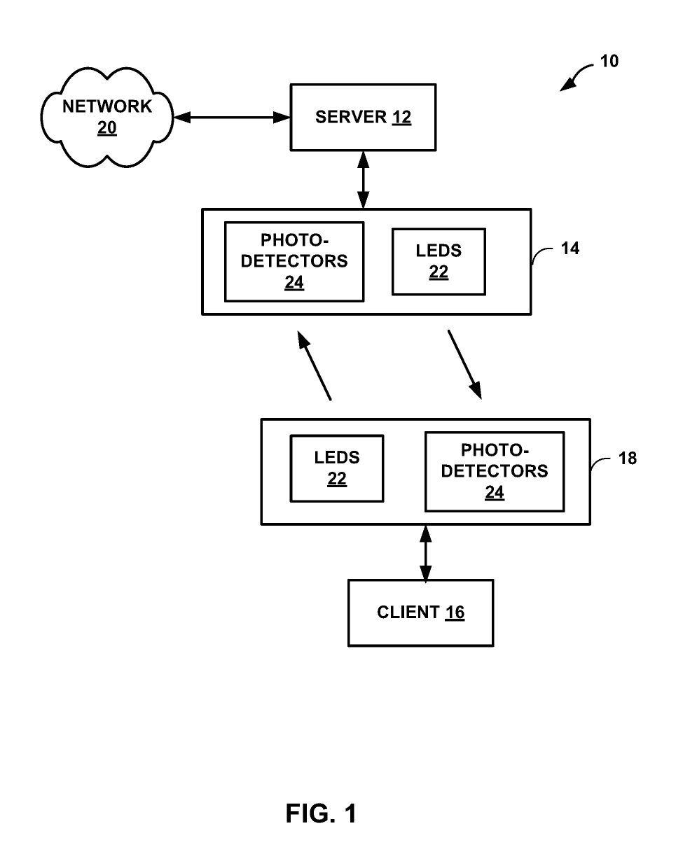

FIG. 1 is a block diagram illustrating one example communication system that may be used with the techniques of this disclosure. The communication system in FIG. 1, shown generally at 10, includes a server computer 12 connected to a server optical transceiver (XCVR) 14, e.g., via a Universal Serial Bus (USB) cable or the like, and a client computer 16 connected to a client optical transceiver 18, e.g., via a USB cable or the like, that generates pulsed light signals for pulsed light communication. Server 12 is in communication with network 20 via a Category (CAT) 5 cable, CAT-6 cable, or the like, for example.

Server optical transceiver XCVR 14 and client optical XCVR 18 are substantially similar in at least one example and, as such, will be described together for purposes of conciseness. Optical XCVRs 14, 18 may include one or more light emitting diodes (“LEDs”) 22 for transmission of light and one or more photodetectors 24 for receiving transmitted light. The term “photodetector” includes “photodiodes” and all other devices capable of converting light into current or voltage. The terms photodetector and photodiode are used interchangeably throughout this disclosure. The use of the term photodiode is not intended to restrict embodiments of the invention from using alternative photodetectors that are not specifically mentioned herein.

In at least one example, the XCVR circuit may include an RS232 to USB conversion module. The transmit pin on the USB conversion module drives the driver electronics for the LEDs. In some embodiments, the XCVR circuit includes high intensity LEDs. In some embodiments it may be desirable to use high intensity LEDs to enhance lighting, to improve data transmission, or both. In at least one embodiment, a 12 volt direct current (DC), 3 amp power supply is sufficient for powering an array of high intensity LEDs 22.

In some embodiments, the XCVR circuit further includes an amplifier for amplifying the optical signal received by the photodiode 24. The output of the amplifier may be fed into level shifting circuitry to raise the signal to TTL levels, for example. The signal is then fed into the receive pin of the RS232 to USB module.

In one example, an alternating current (AC) source such as a line voltage, e.g., 120 Volt (V) provided by an electricity supplier, e.g., power company, can supply power to the XCVR circuit. In some embodiments, a 9V battery can be used to power the amplifier circuitry. Significant noise is generated by switching high brightness LEDs 22 on and off, e.g., at 200 milliamps (mA) and 500 kilobits per second (kbps). Powering the amplifier with a battery can reduce these noise problems by reducing or removing transients.

It should be noted that in some embodiments, the LED 22 can both emit and receive light. In such an embodiment, the LED 22 can act both as a transmitter or receiver, i.e., a transceiver (“XCVR”) 14, 18. More information on such bi-directional LEDs can be found in U.S. Pat. No. 7,072,587, the entire contents of which are expressly incorporated herein by reference.

In at least one embodiment, the optical XCVRs 14, 18, or circuitry attached thereto, include modulation circuitry for modulating a carrier signal with the optical signal. Modulation can be used to eliminate bias conditions caused by sunlight or other interfering light sources. Digital modulation can be accomplished by using phase-shift keying, amplitude-shift keying, frequency-shift keying, quadrature modulation, or any other digital modulation techniques known by those of ordinary skill. Similarly, such XCVRs 14, 18 may include demodulation circuitry that extracts the data from the received signal. Modulation and demodulation techniques for modulating light signals are described in U.S. Pat. Nos. 5,245,681, and 6,137,613, the entire contents of each being expressly incorporated herein by reference.

It may be desirable in some embodiments to further include filters or filter circuitry to prevent unwanted light from being amplified. For example, the optical baseband signal can be modulated at 100 kHz and then transmitted. The XCVR 14, 18 that receives the 100 kHz modulated signal can include a filter stage centered at 100 kHz. The filtered 100 kHz signal can then be input into the amplifier circuitry, thereby preventing amplification of unwanted signals. In some embodiments, it can be desirable to amplify the transmitted signal first, and then filter out the baseband signal.

Additional information regarding data communication can be found in International Publication Number WO 99/49435, the entire contents of which are expressly incorporated herein by reference.

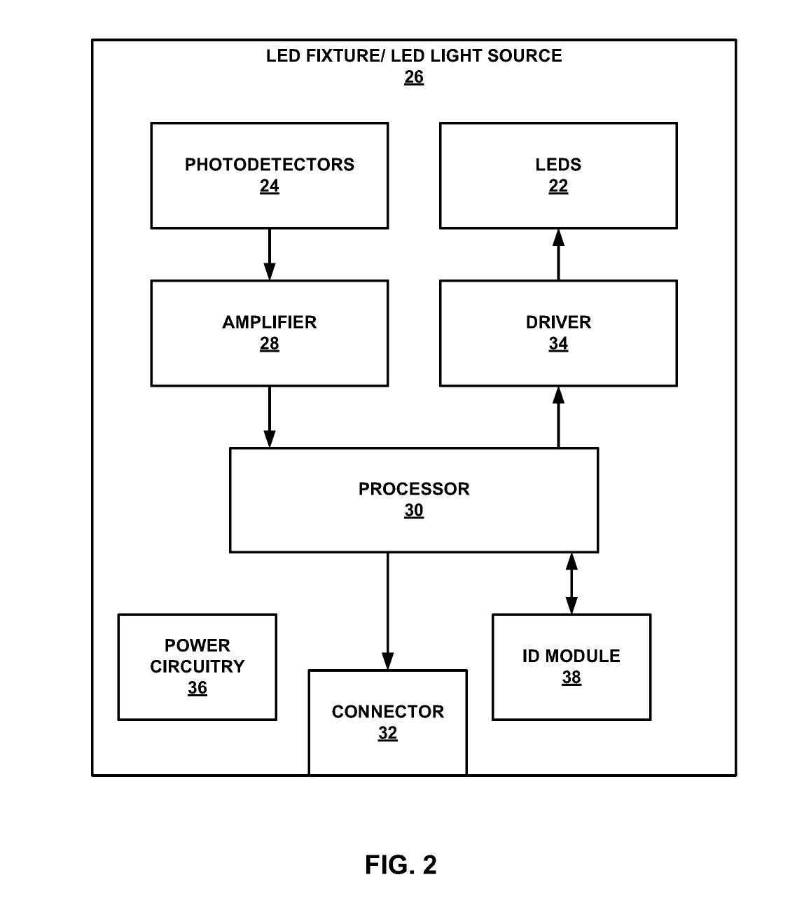

FIG. 2 is a block diagram illustrating an example LED light fixture that may be used with the techniques of this disclosure. LED light fixture 26 is configured to generate and receive pulsed light signals for pulsed light communication. Power and data applied to LED light fixture 26 is converted and transmitted as observable light, which includes pulsed light embedded communication/data signals that, in turn, are received by a transceiver (not shown) in communication with a computing device, for example. The transceiver receives and processes the pulsed light photons/lumens transmitted by LED light fixture 26, which includes embedded communication/data signals as carried by the observed light. The embedded communication signals within the observed light are not detectable by ordinary observation by an individual.

LED light fixture 26 of FIG. 2 includes, for example, photodetectors 24 for converting received light into an electrical signal, e.g., current, and amplifier circuitry 28 that amplifies the electrical signal. The received light may be received from a LED light dongle communication system connected to a client computer, for example, as described in U.S. Patent Application Publication No. 2008/0320200 to Pederson et al., the entire content of which is incorporated herein by reference.

Processor 30 receives a digitized version of the electric signal via an analog-to-digital converter (ADC)(not shown), generates data packets from the digitized signal, e.g., Ethernet data packets, encapsulates the data packets with appropriate header information and the like, and transmits the data packets to another computer device, e.g., laptop computer, desktop computer, and the like, via connector 32. LED fixture 26 may, for example, use broadband over power line (BPL) techniques to transmit the data packets, as described in U. S. Patent Application Publication No. 2009/0129782 to John C. Pederson, the entire content of which is incorporated herein by reference.

The term “processor” as used herein refers to a processor, controller, microprocessor, microcontroller, or any other device that can execute instructions, perform arithmetic and logic functions, access and write to memory, interface with peripheral devices, etc. Processor 30 may take the form of one or more microprocessors, controllers, ASICS, FPGAs, DSPs, or equivalent discrete or integrated logic circuitry. The functions attributed to processor 30 in this disclosure may be embodied as software, firmware, hardware or any combination thereof.

LED light fixture 26 of FIG. 2 further includes LEDs 22 and driver circuitry 34 for transmitting received data, e.g., Ethernet data packets, to client computer 16 of FIG. 1, for example, as light signals. Processor 30 receives data packets via connector 32, e.g., using BPL techniques, and decapsulates the data packets. Processor 30 controls a digital-to-analog converter (DAC)(not shown) and driver circuitry 34 to drive LEDs 22 with an analog signal that represents the received data, thereby generating light signals carrying embedded data.

LED light fixture 26 further includes power supply circuitry 36. As one example, LED light fixture 26 may receive AC line power, e.g., 120 V, and power supply circuitry 36 may include power converter circuitry to convert the line voltage to a direct current (DC) voltage that powers LED light fixture 26.

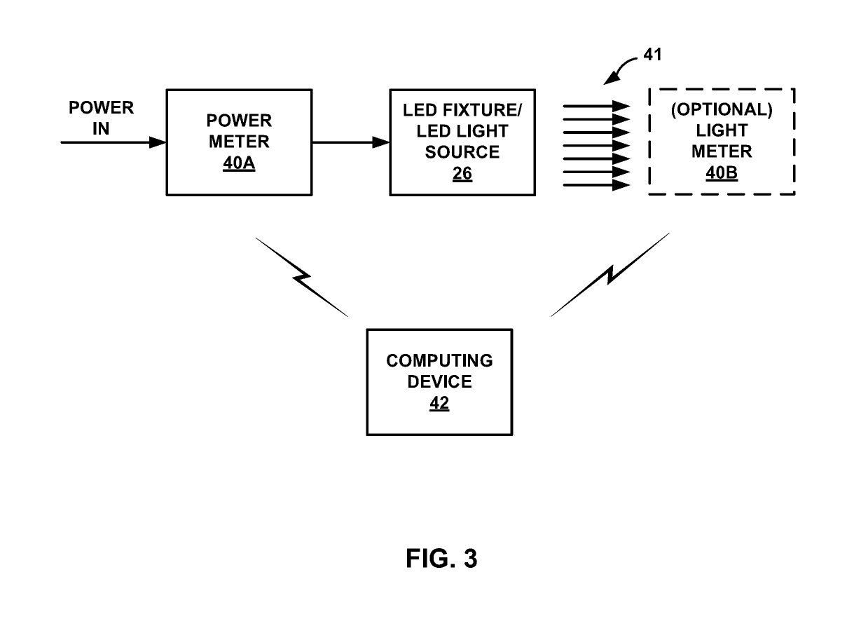

In some examples, LED light fixture 26 further includes identification (ID) module 38. ID module 38 may include global positioning system (GPS) capabilities and/or an identification number, which processor 30 uses to generate a unique identifier for each LED light fixture to assist in the recording of data as measured by individual meters (FIG. 3). In some examples, each LED light fixture 26 may include a unique media access control (MAC) address that can serve as the fixture's unique identifier. In at least one example, LED light fixture 26 may transmit longitude, latitude, elevation and other GPS information, e.g., as a 20-digit number, either at regular or irregular intervals. In one example, the identification number associated with the LED light fixture 26 may also emanate at regular or irregular intervals. ID module 38 provides each LED light fixture 26 with a unique identifier, which assists in the tracking and recording of usage data as measured by individual meters associated with each LED light fixture 26, as described in more detail below.

In some embodiments, each LED light fixture 26 is associated with a meter that measures an amount of electricity used by the LED light fixture. Processor 30 of LED light fixture 26, via ID module 38, generates a unique identifier using a unique identification number and/or GPS location, associates the measured amount of electricity with the unique identifier, and transmits a light signal comprising data representing the associated measured amount of electricity and unique identifier.

In one example, a customer using one or more LED light fixtures 26 has an account with an LED light fixture licensor (or simply “licensor”). Using the techniques of this disclosure, the amount of electricity used to generate photons by LED light fixture 26 may be tracked, quantified, and reported for billing purposes. The transmitted light signal comprising data representing the associated measured amount of electricity and unique identifier can be received, recorded, and assigned to a customer account for recording, processing, and summation, so that a billed expense may be issued by the licensor to the customer, as described in more detail below.

In one example, processor 30 may transmit data including a customer account number and/or customer location number specific to a property or address or floor in situations where the customer has more than one property, address locations, and/or floors. In some examples, in a manner similar to a premise having multiple phone lines, a customer location may have multiple identification numbers that are assigned to floors, or departments on a floor, where a main number is assigned as having a main account number for the customer. It should be noted that LED light fixtures 26 may be mobile or stationary. Even if mobile, the unique identifier associated with each LED light fixture assists in the recording of data as measured by individual meters (FIG. 3).

The costs associated with the use of the LED light fixture and embedded communication/data transmission signals may be less than, and represent a cost savings, as compared to the utilization of traditional types of illumination sources. In at least one example configuration, the embedded communication data transmission signals incorporate security features that may operate in a manner similar to encryption to provide security for the embedded communication data transmission signals.

As described in more detail below, in accordance with various techniques of this disclosure, a provider of LED light fixtures 26 can track and/or quantitatively measure the photons generated by LED light fixtures 26 that provider 44 supplied to a customer. In addition, and in accordance with various techniques of disclosure, the provider 44 has inserted itself between the customer and power company, thereby allowing the provider 44 to generate a revenue stream for the provider 44 based on the tracked and/or quantitatively measured photon generation.

Additional information and details regarding LED light communication systems can be found in the following references, the entire contents of each being expressly incorporated herein by reference: U.S. Pat. No. 8,188,878; U.S. Patent Application Publication No. 2008/0320200; U.S. Patent Application Publication No. 2009/0129782; U.S. Patent Application Publication No. 2008/0317475; U.S. Patent Application Publication No. 2009/0003832; and U.S. Pat. No. 8,188,879.

It should be noted that although various techniques of this disclosure are described with respect to LED light fixture 26, the disclosure is not limited to fixtures. Rather, various techniques of this disclosure may be used in conjunction with any LED light source, e.g., LED lamp and the like. For example, an LED light source, e.g., LED lamp, may include one or more components described above with respect to LED light fixture 26.

FIG. 3 is a block diagram illustrating an example metering configuration for an LED light fixture, in accordance with various techniques of this disclosure. As seen in the example configuration depicted in FIG. 3, both the line-in side (from the electricity supplier, e.g., power company) and line-out side of LED light fixture 26 may include a meter. In particular, FIG. 3 depicts meter 40A receiving power (e.g., AC line power from a power company, or DC power). Meter 40A measures the amount of current drawn by LED light fixture 26 and the voltage at which the current is drawn. Hence, meter 40A may be considered a power meter, or may be considered to perform a power metering function. Meter 40A transmits the measured current and voltage to LED fixture 26 and, in particular, processor 30 of LED fixture 26 as power consumption data. Processor 30 of fixture 26 then associates the received power consumption data with the unique identifier of fixture 26 and either stores the data in memory, e.g., FLASH RAM or the like (not depicted), or transmits the associated data, as described above. In this manner, the amount of electricity used by LED light fixture 26 to generate photons and/or visible light can be tracked, quantified, and reported for billing purposes. Meter 40A provides a “sub-metering” function that allows the electrical consumption of each LED light fixture 26 to be determined.

The measurement of the visible light and/or photons may be in any quantitative measurement per given period of time as opposed to hour increments. The measurement of the photons generated may be referred to photons per hour or photons per some other period of time.

In some configurations, meter 40B is provided. Optional meter 40B measures the luminosity (or quality of the luminosity) of LED light fixture 26, by measuring the amount of lumens produced by LED light fixture 26. In particular, meter 40B receives light emitted from the LEDs of fixture 26, shown generally at 41 in FIG. 3, meter 40B determines the luminosity of light 41 emitted from the LEDs of fixture 26 (and, in some examples, the color of light 41 for color correction purposes), and meter 40B transmits the determined luminosity to LED fixture 26, and, in particular, processor 30 of LED fixture 26 or to computing device 42 (which will transmit the determined luminosity to LED fixture 26). Upon receiving the determined luminosity from meter 40B, processor 30 of LED light fixture 26 retrieves from a memory device in fixture 26 (not depicted) a luminosity value, e.g., pre-configured value stored in the memory device, and compares the luminosity value measured by meter 40B to the value retrieved from memory. Meter 40B may be considered a light (or lumen) meter, or may be considered to perform a light (or lumen) metering function.

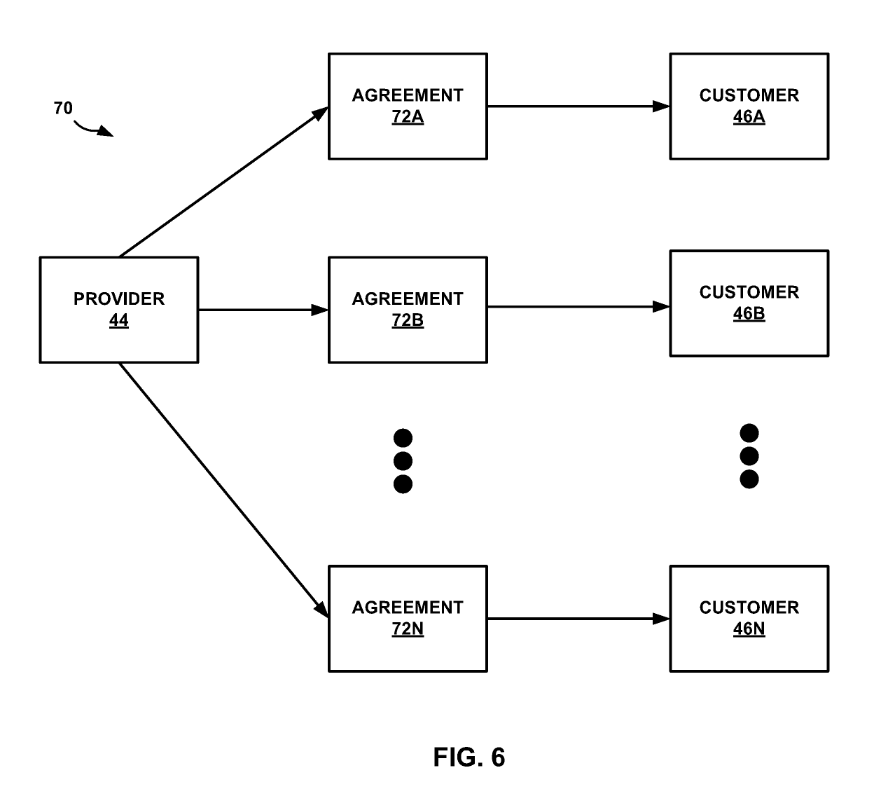

If processor 30 determines that the luminosity value as measured by meter 40B is less than the value retrieved from the memory device, processor 30 controls driver circuitry 34 of fixture 26 to increase the amount of current applied to LEDs 22, thereby increasing the amount of light output from LEDs 22 which, in turn, increases the luminosity of LED light fixture 26. For instance, an agreement between the LED light fixture customer and the LED light fixture provider, e.g., agreement 72A of FIG. 6, may include a provision that the provider, e.g., provider 44 of FIG. 6, agrees to provide an amount of lumens or luminosity 41 to the customer, e.g., customer 46A of FIG. 6, for an agreed upon price over an agreed upon time period. As LEDs 22 of fixture 26 degrade over time from use and produce less light (in response to a particular applied current level), processor 30 of fixture 26 controls driver circuitry 34 to increase the amount of current applied to LEDs 22 in order to provide the agreed upon amount of lumens or luminosity 41. In this manner, meter 40B aids in calibrating LED light fixture 26 so that the fixture is in compliance with the agreement between the customer and the provider.

Of course, as more current is applied to LEDs 22, meter 40A measures an increase in power consumption by fixture 26. As fixture 26 ages and requires more power to produce a given lumen output, the profit to the provider is reduced because the amount of money that the customer pays the provider for a given lumen output is independent of how much electricity is required to produce that given output. The electrical cost paid by the provider 44 to the electricity supplier and the provided lumen output are predetermined.

In one example, processor 30 of LED light fixture 26 controls driver circuitry to increase the amount of current applied to LEDs 22 based on values stored in a memory device in LED light fixture 26. For example, a data structure, e.g., table, stored in the memory device may associate a set of luminosity values with a set of current values to be applied to LEDs. Processor 30 accesses the data structure, compares the measured luminosity value from meter 40B with the stored set of luminosity values, and retrieves a current value associated with that luminosity value (or a value close to it) from the stored set of current values. Then, processor 30 controls driver circuitry 34 to apply the retrieved current value to LEDs 22.

In some examples, a master computer, e.g., computing device 42, may query one or more of LED light fixtures 26 in order to retrieve the stored luminosity information and/or power consumption information. If appropriate, the master computer controls processor 30 of LED light fixture 26 to adjust its light output.

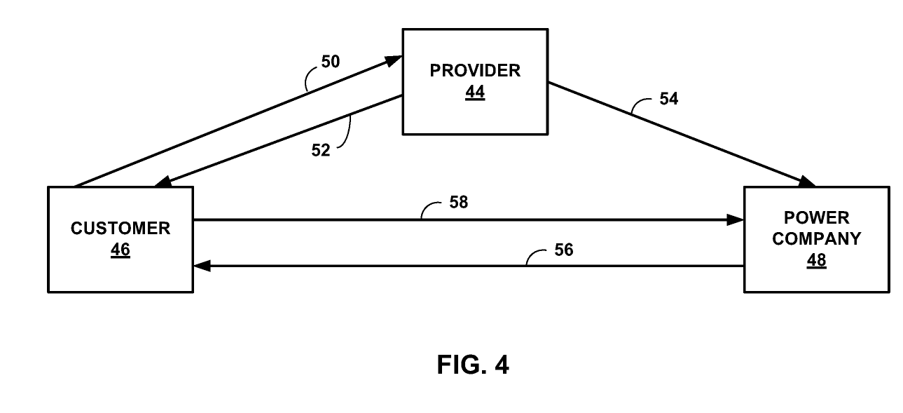

In some configurations, only the line-in side meter 40A is used. It should be noted that in some example configurations, meters 40A, 40B are integral with LED light fixture 26 such that meters 40A, meter 40B (if present), and LED light fixture 26 form a single unit. In one example configuration, meters 40A, 40B are separate components that are external to and in communication with LED light fixture 26. In some examples, the LED light fixture provider (provider 44 of FIG. 4) maintains the line-in side meter 40A.

The power entering LED light fixture 26 is converted by LED light fixture 26 into observable light, which includes pulsed light embedded communication/data signals. The light, in turn, is received by another transceiver that processes the pulsed light photons/lumens to process and communicate the embedded communication/data signals as carried by the observed light. The embedded communication signals within the observed light are not detectable by ordinary observation by an individual.

FIG. 3 further depicts computing device 42. Computing device 42 is any device capable of communicating with meters 40 and storing and processing data related to the amount of electricity used by LED light fixture 26 to generate photons and/or visible light. Accordingly, computing device 42 includes, for example, one or more processors, memory for storing instructions executable by the one or more processors as well as data, and communication functionality. In one example, computing device 42 may be remotely located at the LED light fixture provider's premises and owned and operated by the provider 44. In another example, computing device 42 may be positioned on the customer's site and either owned and operator by the provider or owned and operated by the customer.

In at least one example configuration, an LED light fixture customer has an account with the LED light fixture provider. For each LED light fixture 26, processor 30 transmits data packets comprising the electricity usage measured by meter 40A (and if present, the lumens measured by meter 40B), and the unique identifier for the LED light fixture 26. Processor 30 may execute instructions, without user intervention, that cause processor 30 to periodically transmit the data packets comprising the electricity usage measured by meter 40A (and if present, the lumens measured by meter 40B) and the unique identifier for the LED light fixture 26, e.g., daily, weekly, bi-weekly. Or, in some examples, processor 30 may execute instructions, without user intervention, that cause processor 30 to almost continuously transmit the data packets comprising the electricity usage measured by meter 40A (and if present, the lumens measured by meter 40B) and the unique identifier for the LED light fixture 26, e.g., once per minute, every other minute, every five minutes, or some other time interval. In other examples, processor 30 may respond to a user request, e.g., via computing device 42, and execute instructions that cause processor 30 to transmit the data packets comprising the electricity usage measured by meter 40A (and if present, the lumens measured by meter 40B) and the unique identifier for the LED light fixture 26.

The meter is assigned to a customer account for recording, processing, and summation, so that a billed expense may be issued by the provider to the customer. In one example, the provider may estimate the amount of electricity that will be used by the LED light fixtures 26 on the customer's premises, e.g., in the first year after installation of the LED fixtures.

Regardless of whether meters 40A, 40B are integral with LED light fixture, the functions attributed to meters 40A, 40B in this disclosure may be embodied as software, firmware, hardware or any combination thereof.

FIG. 4 is a block diagram illustrating an example LED light fixture 26 agreement between a customer and a licensor, in accordance with this disclosure. FIG. 4 depicts three entities, namely LED light fixture provider 44, LED light fixture customer 46, and power company 48 (also referred to as an “electricity supplier”). LED light fixture customer 46 is an entity that uses one or more LED light fixtures 26 supplied by LED light fixture provider 44. In accordance with a contractual agreement between provider 44 and customer 46, customer 46 agrees to pay provider 44 a pre-determined monetary amount for each LED light fixture 26 supplied to customer 46 by provider 44, as indicated by line 50, as compensation for the photons generated by the LED light fixtures. Within the photons received by the customer is embedded pulse light communication and/or data. In return, provider 44 agrees to provide customer 46 with LED light fixtures that can provide illumination, embed receivable data within the illumination, and receive data embedded within transmitted light signals, as indicated by line 52.

Additionally, as part of the contractual agreement between provider 44 and customer 46, provider 44 agrees to pay the electricity supplier, e.g., power company 48, on behalf of customer 46, a monetary amount for the cost of the electricity used to generate the photons by each LED light fixture 26 on the customer's premises. The payment made by the provider to the electricity supplier is used as a credit against any account balance owed by the customer 46 to the electricity supplier 48. To facilitate this payment, the customer may provide the LED light fixture provider 44 with the name of the customer's electricity supplier 48, e.g., the local power company, and the customer's account information with the electricity supplier 48.

As described above, meter 40A (FIG. 3) is used to determine the amount of electricity used to generate the photons by each LED light fixture 26. During each power company billing period, for example, provider 44 pays power company 48 (into an account associated with customer 46) a monetary sum equal to the total cost of the electricity used to generate the photons for all LED light fixtures 26 on the customer's premises, as indicated by line 54. The difference between what customer 46 agreed to pay provider 44 as a pre-determined monetary amount for each LED light fixture 26 supplied to customer 46 by provider 44 (line 50) and what provider 44 pays power company 48 as a monetary sum equal to the total cost of the electricity used to generate the photons for all LED light fixture 26 on the customer's premises (line 54) is realized as a profit for provider 44.

By way of specific example, assume that customer 46 enters a contractual agreement with provider 44 and has two LED light fixtures on the customer's premises. In the agreement, customer 46 agreed to pay provider 44 $2.50 per fixture, per 30 day billing period, in perpetuity as compensation for the photons generated by the LED light fixtures 26. During a power company 48 billing cycle, e.g., 30 days, provider 44 determined, via one or more meters 40A, that the two LED fixtures on the customer's premises consumed electricity totaling $2.25 per fixture. Per their agreement, provider 44 deposits, transfers, or otherwise establishes a credit with the customer's account at power company 48 in the amount of $4.50 ($2.25*2 LED light fixtures). Because provider 44 received from customer 46 $5.00 ($2.50*2 LED light fixtures) as compensation for the photons generated by the LED light fixtures 26 per 30 day billing period, provider 44 realizes a profit of $0.50 for that particular billing cycle. In this manner, using the techniques of this disclosure, provider 44 can track the photons generated by the LED light fixtures 26 that provider 44 has supplied to customer 46. In addition, and in accordance with various techniques of disclosure, provider 44 has inserted itself between customer 46 and power company 48, thereby allowing provider 44 to generate a revenue stream for provider 44 based on the tracked photon generation.

Still referring to FIG. 4, customer 46 and power company 48 have a contractual agreement in which customer 46 is financially obligated to pay power company 48 for the expense of power consumed by customer 46 that is in excess of the amount credited by provider 44 to the customer's account with power company 48. The excess power expense may be incurred by the customer 46 by use of electrical devices that are not associated with LED light fixtures 26 that include embedded communication and/or data, e.g., traditional light sources other than the LED light fixtures 26 or electricity used by other electrical devices. In accordance with their agreement, power company 48 agrees to supply customer 46 with electricity (indicated by line 56) and customer 46 agrees to pay power company 48 a monetary amount for the electricity consumed (indicated by line 58). As described above, provider 44 pays power company 48 a monetary sum equal to the total cost of the electricity used to generate the photons or all LED light fixtures 26 on the customer's premises (line 54). Customer 46, however, has likely consumed electricity beyond that used to generate photons for all LED light fixtures 26 on the customer's premises. Hence, customer 46 owes power company 48 a monetary sum equal to the difference between the credits applied to the customer's account by provider 44 and the excess consumed electricity. Power company 48 bills customer 46 for the difference.

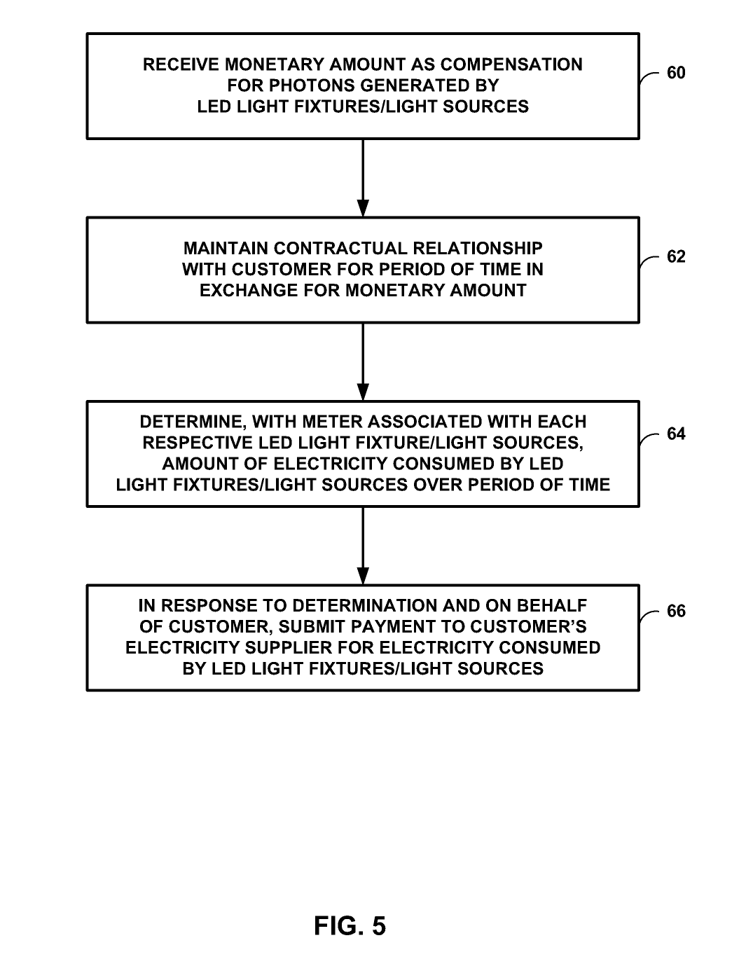

FIG. 5 is a flow chart illustrating an example method of compensating an LED light fixture provider 44 for generation of photons by one or more LED light fixtures 26 used by a customer. In the example method of FIG. 5, an LED light fixture provider, e.g., provider 44, receives from an LED light fixture customer, e.g., customer 46, a pre-determined monetary amount as compensation for photons generated by LED light fixtures 26 installed at the customer's premises (60). Provider 44 may receive the pre-determined monetary amount on a periodic basis, e.g., weekly, monthly, or yearly. In other words, provider 44 may receive a payment from the customer 46 at a regular interval corresponding to a period of time, as agreed upon by provider 44 and customer 46. For example, assume that customer 46 enters a contractual agreement with provider 44 and has two LED light fixtures on the customer's premises. In the agreement, customer 46 agreed to pay provider 44 $2.50 per fixture in perpetuity as compensation for the photons generated by the LED light fixtures.

Per a previously entered into contractual agreement, provider 44 maintains a contractual relationship with customer 46 for a period of time in exchange for the pre-determined monetary amount, the contractual relationship including a requirement that provider 44 pay the customer's electricity supplier, e.g., power company 48, for the electricity consumed by the LED light fixtures (62) used by the customer. The method of FIG. 5 further includes determining, with a meter associated with each respective LED light fixture, e.g., meter 40A, the amount of electricity consumed by the LED light fixtures used by the customer over a period of time (64). Then, in response to the determination and on behalf of customer 46, provider 44 submits payment to the customer's electricity supplier, e.g., power company 48, for the electricity consumed by the LED light fixtures 26 (66) used by the customer.

FIG. 6 is a block diagram of an example system for compensating an LED light fixture provider for generation of photons by LED light fixtures 26 used by a customer 46. The system, shown generally at 70, includes LED light fixture provider 44 establishing and maintaining a contractual agreement, e.g., agreement 72A, with an LED light fixture customer, e.g., customer 46A. Provider 44 may establish and maintain additional contractual agreements, e.g., agreements 72B-72N (each agreement referred to generally in this disclosure as “agreement 72”) with additional customers 46B-46N, respectively, (each customer referred to generally in this disclosure as “customer 46”).

LED light fixture provider 44 may be a LED light fixture manufacturer, LED light fixture retailer, or LED light fixture distributor, or any other party capable of providing LED light fixtures. Customer 46 is any person, organization (public or private), or other entity capable of receiving, maintaining, and operating an LED light fixture, e.g., LED light fixture 26. Examples of customers include, but are not limited to, government entities (e.g., city governments), school districts, shopping malls, private businesses, individuals, airports, and the like.

Agreements 72 include any legally binding instrument, electronic or tangible, capable of establishing a contractual relationship between a customer, e.g., customer 46A, and a provider, e.g., provider 44, (“the parties”). Agreements 72 set forth the terms and conditions of the contractual relationship between the parties. In one example, agreements 72 are tangible agreements that may be signed by the parties. In other examples, agreements 72 are “click-thru” agreements in which the customer, e.g., customer 46A, manifests assent by clicking an “ok” or “agree” button or the like on a dialog box or pop-up window.

Per each agreement 72, the customer, e.g., customer 46A, agrees to pay LED light fixture provider 44, a pre-determined monetary amount as compensation for photons generated by LED light fixtures 26 installed at customer 46A's premises. In exchange for the pre-determined monetary amount, provider 44 agrees to pay the customer's electricity supplier, e.g., power company 48, for the electricity consumed by the LED light fixtures used by the customer. Because provider 44 will generally receive from the customer, e.g., customer 46A, a compensatory amount greater than the cost of the electricity usage, provider 44 realizes a profit and generates a revenue stream.

In some examples, the agreement between the parties includes three or more phases, e.g., stages. In other examples, the agreement between the parties includes less than three phases.

In one example, the use of LED light fixtures having embedded communication/data signal transmissions capabilities is an infrastructure change to the customer. In some examples, in at least one phase the agreement requires the customer to pay to the provider an agreed-upon price for manufacture and installation of each LED light fixture. The provider retains ownership of the LED light fixture in some examples. In at least one example, the customer may also lease from the LED light fixture provider one or more USB Internet transceivers for an agreed-upon price.

In at least one example, payment of the agreed-upon installation price and execution of the agreement, e.g., agreement 72A, places the customer, e.g., customer 46A, in a priority position relative to other customers which enter into the contract with provider 44 at a later date. In one example, early entry into an agreement with provider 44 affords priority to the customer with respect to installation or service of LED light fixtures at additional locations (to be identified at a future date) or when the customer adds additional designated locations or fixtures within a particular property. That is, the customer's execution of the agreement places the customer in an established position in a queue with respect to installation and/or service of additional LED light fixtures at the customer's facility. The faster that the customer establishes its priority in the queue, then the faster the customer will start saving energy and receiving embedded communication/data services.

In one example, the agreement with the customer will include a charge and an agreement that the customer pays for the equipment necessary in phase 1 of the contract. Phase 2 of the agreement may, in some examples, have another equipment charge for additional LED light fixtures and the installation of additional LED light fixtures. In some examples, the equipment charge and/or the installation charge per light fixture in phase 2 is lower than in phase 1, due to economies of scale.

Customers may save costs by using LED light fixtures, which eliminate the expenses associated with conventional light sources, the replacement costs associated with conventional light sources, the labor costs associated with the replacement of conventional light sources, the labor costs associated with bookkeeping, tracking, and payments associated with conventional light sources, the expense of purchasing lights, receiving lights, unpacking lights, distributing lights, installing lights, removing and disposing of exhausted lights, breakage of purchased lights, storage of purchased lights, retrieval of lights, replacing ballasts and sockets and the accounting associated with the above tasks.

In addition, the cost may vary between locations and/or facilities for a customer. It should be noted that the expenses as identified above are representative of examples, and by no means are exhaustive of all of the direct and/or indirect expenses associated with a conventional light source. Using LED light fixtures 26 may eliminate a number of the above identified expenses for the customer.

In one example, provider 44 is responsible for the ongoing expense associated with the replacement of an LED light fixture. In other examples, customer 46 may be responsible for the agreed-upon expense associated with the manufacturer, installation, and/or replacement of an LED light fixture.

In some examples, provider 44 assists customer 46 in identifying the costs associated with conventional illumination sources so that an actual cost savings may be identified and communicated to individuals having decision authority to minimize waste of resources by the customer. In at least one embodiment, the use of LED light fixtures including embedded communication/data, conserves and saves natural resources reducing the stress on the environment.

In one example, the parties agree on a value and/or expense associated with the use of the conventional light sources so that expense savings resulting from the use of the LED light fixtures may be identified and realized. Provider 44 may, in some examples, determine or assist in the determination of an average expense incurred by a customer that uses conventional light sources.

The typical light bulb (or other conventional illumination source) following installation generally produces less light as the bulb ages even though the bulb consumes the same amount of power over time. A reduction in the produced illumination of a conventional light source may be due to dirt, deposits on the outside or inside of the gas, gas leakage, and/or wear in the filament. In one example, provider 44 assists customer 46 in identifying and quantifying intangible expenses associated with a conventional light source such as reduced productivity, downtime, discussions and communications related to service and maintenance, as well as/or loss of productivity due to frustration. In at least one example, provider 44 prepares a chart of the usual expenses and cost savings associated with the use of LED light fixtures as compared to conventional light sources.

In one example implementation, the cost savings realized by the customer equals the difference in the calculated and agreed upon composite costs associated with the use of traditional light sources following consideration of the factors identified above, less the amount that has been agreed to be paid to the provider for the use of the LED light fixtures having embedded communication/data transmission. The customer may, for example, finance the installation and manufacture costs associated with the LED light fixtures having embedded communication/data transmission by continuing to pay to the provider the entire amount as agreed upon by the customer and/or provider of the actual previous cost expense incurred by the customer for the use of conventional light sources, following the consideration of the above identified factors.

In at least one example, the customer may finance the initial installation and manufacturing expenses for one or more LED light fixtures in a manner similar to a performance contract. Factors considered by the customer are present capital expenditure outlay and incurred immediate operational savings versus continuous payment of a previous level of expenditure and realization of operational savings at a future date once financing is liquidated/exhausted. In at least one example, the initial capital investment is available where ongoing operational expenses are problematic, where the ongoing cost savings associated with the use of the LED light fixtures with embedded communication/data transmission enables the customer to afford to proceed with the use of LED light fixtures as an ongoing operational expense.

In at least one embodiment, pursuant to the contractual agreement, the customer 46 will agree to compensate provider 44 an agreed upon fixed sum, in addition to the metered electricity consumed by the LED light fixtures/LED light sources (62) used by the customer 46, for each agreed upon period of time. In at least one embodiment, pursuant to the contractual agreement, the customer 46 will agree to compensate provider 44 an agreed upon multiplier of the metered electricity consumed by the LED light fixtures/LED light sources (62) used by the customer 46, for each agreed upon period of time. It should be noted that any other method or type of compensation enhancement from the customer 46 to the provider 44 above the metered electricity consumed by the LED light fixtures/LED light sources (62) used by the customer 46, is contemplated under this invention. It is anticipated that the contractual relationship will include a requirement that provider 44 pay the customer's electricity supplier, e.g., power company 48, for the electricity consumed by the LED light fixtures/LED light sources (62) used by the customer or for the photons generated from an LED light fixture 26.

General illumination, for all extensive purposes, has never been offered as a service to conventional business or homeowner. Illumination may be provided in measured increments of a Data-Lumen hour (DLh). A Data-Lumen hour (DLh) combines a lumen hour with data communication. A lumen hour is a measure of light produced by a light source in a given period of time. It is calculated by multiplying the amount of light created, in lumens, by the time, in hours, over which it was created. (A lumen is a measure of visible light emitted from a light source.) A 1000 lumen light, operating for two hours, produces 2000 lumen hours, or two kilolumen hours. When that light, denominated in kilolumen hours, also provides, or is capable of providing, communication through visual light communication technology, the light and data communication is called a Data Lumen-hour.

A Lumen-hour (Lh) is a unit of light energy equivalent to the light output of one lumen produced over a period of one hour. For example, a lamp rated at 2500 lumens (2.5 kilo Lumens) operating for 4 hours produces 10,000 Lh.

As a conceptual reference, 1000 Lh is approximately equal to the light produced by a standard 75 watt incandescent light bulb operating for one hour. In comparison, a standard 33 watt T8 fluorescent lamp produces approximately 2500 Lh when operated for one hour.

In some embodiments, a Data Lumen-hour (DLh) is a unit of visible light incorporating embedded visible photonic manipulation as to create a wireless, fibreless high speed data stream of encoded communication using the same light used as illumination, thereby enabling a commercial communication and energy proposition of two services from one essential medium, namely light. High speed data communications within a DLh operation are non-perceivable to the human eye.

In some embodiments, an entity offering the DLh service is known as a “Hosting Customer”. The user wishing to acquire access to the DLh service, or network service such as the internte, is known as the Client User. The Client User may be billed in units of Data-Lumen hours (DLh) or Data Lumen-minutes (DLm).

In some embodiments, a mega Lumen-hour (MLh) is one million Lumen-hours (Lh); it is the approximate equivalent amount of light produced by a single 4-foot T-8 32 watt bulb running for 315 hours.

In some embodimetns, the provision of lumen hours Lh(s) includes the 1) purchase of electricity, 2) direction of the electricity into an LED lamp or LED lamp fixture using electrical current transmission, 3) metering the electrical current flow, 4) knowing the performance and status of the LED lamp and its calibrated efficiencies, 5) metering the LED lamp photon output, applying metrics and quantifying the LED lamp output (brightness×run time=Lh total), 6) assigning a monetary value including cost of service and profit to each Lh, and 7) invoice and collecting payment for Lh(s) from a willing customer.

In at least one embodiment, light generated from an LED light fixture may be modulated to emit visible light photons in such a way as to not be perceived by the human eye, but detected and encoded/decoded by electronic apparatus. This effectively accomplishes high speed free space wireless data communication using the same light visualized by an individual.

In one embodiment, a “Lumen-hour” is equivalent to the light emitted from a two-bulb, 32 W, T-8 fixture for 0.73 of a second. In some embodiments, due to the efficiencies of the LVX T-8 bulb, illumination of the two T-8 bulbs will occur for 1.10 seconds. In some embodiments, it is practical to measure Lumen-hours in Millions or “Mega” Lumen-hours or (mLh). A mLh will be equivalent to the illumination of a two-bulb fluorescent T-8 lamp fixture 200 hours and an equivalent LVX T-8 fixture for 300 hours.

In some embodiments, each DLm used by a customer could generate to a Hosting provider a commission of 0.0050/minute or more. In some embodiments, if a Client customer accessed a particular LED light fixture for DLh communications approximately 75 seconds it would pay the LVX service charge of the Hosting provider for one operational hour. In some embodiments, 15 minutes of access by a client customer on a particular LED light fixture to use DLh communications could pay for a twelve hour day of the Hosting provider. In some embodiments, with multiple Client users accessing a singular fixture, a DLh can generate more than 60 DLm.

In at least one embodiment, a user may establish a client account, and the user may access the pulsed light communication/data system through the use of a key or dongle device as interfaced with the USB port of a computer to provide access to data recorded as DLh in areas or spaces where pulsed light communications are available. Such individuals establish a Client Account System and may use a Key to access the System network with their computers.

In at least one embodiment, a client service is billed to Client Customers on a DLm basis. This service strategy may be similar to standard cell phone “minutes” used by communication companies to bill customers for data consumption. In some embodiments, pulsed light communication/data services may be divided into three distinct services, namely: Static Data Lumen-hour (DLhₛ) Service; Dynamic Data Lumen-hour (DLh_{d}) Service; and/or Data Lumen-minute Service. In some embodiments, LED pulsed light fixtures may be installed at a Hosting Customer's Premises, including: Stationary (static) locations, such as office buildings or homes; and/or Moving (dynamic) locations, such as airplanes or trains or other vehicles.

In some embodiments, client customers may establish Facility Networking Accounts, which provide free DLm access for internal networking at the client customer's facility.

In some embodiments, traditional energy companies deliver services on a kilowatt-hour basis. In some embodiments, in illumination and data communication may be delivered to Hosting Customers, such as building owners, on a Data Lumen-hour (DLh) basis. In at least one embodiment, a provider of illumination and data communication may pay for the electricity consumed by LED lights or light fixture at a customer location. In some embodiments, electricity is fundamentally at least one cost of service and LED lights may be queried electronically using both hardware and software based processes to determine consumed electricity and illumination produced by the LED lights.

In some embodiments, customers lease LED Lights, and the LED light or LED light fixture provider provides to the customer system/network access, communication services, network support, and routine upgrades and maintenance.

In some embodiments, an LED light or LED light fixture provider will monitor how much electricity the LED lights/fixtures consume at a Hosting Customer's facility, and the illumination/data services provider may pay the power utility for the cost of the consumed electricity. The electrical expense for the LED illumination in some embodiments may show up as a credit on the power utility bill that customers receive from their local utilities. Therefore, the electricity consumed by the LED lights is a cost of service to the illumination/data services provider, incentivizing the illumination/data services provider to deliver the most energy efficient technology available because expense is reduced when energy costs are minimized.

Hosting Customers are any customers who provide an illumination/data service communication hotspot by installing and commissioning LED lights in a Static Hosting environment. In some embodiments, the owner of any building, facility, or location where communication using LED illumination/data services are to be provided may be a Static Hosting Customer.

In some embodiments, to enhance the energy and operational cost savings realized when using the LED illumination/data communication services, revenue from client usage may be shared with Hosting Customers. In some embodiments, Hosting Customers participating in revenue sharing generated from the provision of the LED illumination/data communication services still pay a Data Lumen-hour (DLh) fee to the LED illumination/data communication service provider which maintains their lighting, but the overall costs for the LED illumination/data communication service and LED light installations may be reduced. For example, a coffee shop with LED lights could realize revenue from their customers who use the LED illumination/data communication service while eating at the coffee shop.

In some embodiments, a Hosting Customer may choose to incorporate Internet connectivity but prohibit the use of texting on the LED illumination/data communication service networks. For example, an airport may choose to integrate Internet connectivity, texting, and additionally request integrated cameras for facial recognition and greater terminal security. Certain features, such as the ability to make emergency calls to fire or police stations, will not be limited or withheld for payment.

In some embodiments, a Static Hosting Customers will pay a Data Lumen-hour (DLh) fee to the LED illumination/data communication service provider. This fee may cover basic lighting maintenance and network connectivity capabilities.

In some embodiments, Static Hosting Customers may share the expense of installing LED lights with budgets dedicated to future data expansion requirements throughout their facilities. In some embodiments, a Static Hosting Customer may consider the LED lights were provided without expense because of the expense saved on required data expansion and operational cost savings, which will be realized into the future, while receiving a superior, secure lighting and communication system.

In some embodiments, the LED illumination/data communication Hosting Service may be billed to Hosting Customers on a mega Data Lumen-hour (mDLh) basis. In at least one embodiment, a typical LED light containing 4 T8/3 Mb LED lamps produces approximately 1.7 mDLh per month. In some embodiments, a LED illumination/data communication service provider may charge a customer an assigned amount of expense per LED Fixture per month. In some embodiments, the assigned monthly expense results in an expense savings per month when compared to the cost to run an equivalent fluorescent fixture with 2 standard 32 watt T8 lamps.

In some embodiments, a T8-3 Mb LED Lamp consumes 12 watts and has an efficacy (lighting efficiency) of 104 lumens per watt. At this efficacy, this LED Lamp produces 1,248 lumens while consuming 12 watts (0.012 kW) of electricity.

The expense for a DLkh or Data Lumen kilowatt hour may be set at $0.117 per kilowatt hour or higher where the national average electrical expense is $0.0014 for electricity during one hour of operation. In one hour of operation, $0.0014 of electricity is needed to produce 1,248 Lumens. The electrical cost to produce each Lh equals $0.00000112, or $1.12 per mega Lh (mLh). A mega DLh (mDLh) is equal to a mLh plus the cost of providing the LED illumination/data communication services. This additional cost includes a fixed maintenance cost. Maintenance costs are calculated as approximately 20.5% of mLh costs, or $0.23. The total DLh price in some embodiments may equal $1.58.

In some embodiments, a standard T8 fluorescent lamp consumes 32 watts and has an efficacy (lighting efficiency) of 78 lumens per watt. At this efficacy, a T8 lamp produces 2,496 lumens in one hour while consuming 32 watts (0.032 kW) of electricity. At $0.117 per kilowatt hour (national average electrical cost), a standard T8 lamp using 0.032 kW consumes $0.0037 of electricity in one hour of operation. In one hour of operation, $0.0037 of electricity is needed to produce 2,496 Lumens. The cost to produce each Lh equals $0.0000015, or $1.50 per mLh. According to lighting industry standards, the life cycle energy cost to produce each mLh. Therefore, life cycle costs equal $0.61 per mLh and include maintenance costs such as re-lamping, ballast replacement, lens replacement, etc. The total cost per mLh to operate a standard T8 fluorescent lamp equals $2.11.

If, in a given month, defined as 30.4 days [365/12=30.4], a fixture is assumed to operate for 11.2 hours a day (commercial lighting standard as defined by the Department of Energy), then the total hours of operation per month per fixture equals 340.5 hours. A standard fluorescent lamp is rated at 2,496 lumens. Operating for 340.5 hours a month gives a total output of approximately 849,000 Lh, or 0.849 mLh. In one month, 0.85 mLh at $2.11 per mLh, yields monthly operating cost of $1.79 per standard fluorescent lamp. Assuming a standard 2′×2′ fluorescent fixture contains 2 T8 fluorescent lamps, at a monthly of cost $1.79 per lamp, said fixture costs $3.58 per month to operate.

A T8-3 Mb LED Lamp is rated at 1,248 lumens. Operating for 340.5 hours a month gives a total Lh output of approximately 425,000 Lh or 0.425 mLh. In one month, producing 0.425 mDLh at $1.58 per mDLh, yields monthly operating costs of $0.672 per Lamp.

A standard T8 fluorescent lamp has a lumen rating of 2,496 lumens. An LED Lamp has a lumen rating of 1,248. This is half the lumen rating of a standard T8 fluorescent. Therefore, two LED T8-3 Mb LED Lamps are equivalent (in lumen output) to one standard T8 fluorescent lamp. Four LED Lamps are needed to replace a standard 2 lamp T8 fluorescent fixture. At a monthly cost of $0.672 per LED Lamp the monthly costs to run a fixture with 4 LED Lamps is $2.69.

In some embodiments, the provision of LED illumination/data communication services not only provides secure wireless communication and other value, but also has the potential to save customers $0.89 per standard T8 fluorescent fixture (on average) at their facility every month. These savings represent a 25% reduction in lighting costs.

In some embodiments, the provider of LED illumination/data communication services may enter into bulk electricity purchases from an electrical provider.

In some embodiments, the expense for the provision of LED illumination/data communication services includes the expense for: Energy (kWh) necessary to power LED Lights; Maintenance fees on LED Lights; Labor for commissioning, field testing and final calibration of newly installed LED Lights (this is separate from Installation Labor); Costs related to the purchase of bulk third party services associated with premium services; Depreciation (on a straight line basis over 10 years); and a Technology Fee, paid on recognized revenue.

In some embodiments, the LED Lights and associated apparatus are owned by the provider of the LED illumination/data communication services and are not sold to the customers subscribing to the LED illumination data communication services, where the cost to build and install LED Lights are capitalized by the provider of the LED illumination/data communication services rather than being shown as a cost of sales.

In some embodiments, software will enable an LED illumination/data communication service provider to monitor both electrical consumption and lumen output for the LED Lights.

In some embodiments, a customer of LED illumination/data communication services will be required to provide compensation for a non-refundable Equipment Usage Charge for receiving access keys or dongles and be required to pay: Equipment Usage Fee; Basic installation & Equipment Usage Fee; Extended installation & Equipment Fee; Data Lumen minute (DLm) Fee; Minimum Access Fee; or a Data Lumen hour (DLh) Fee; a standard rate fee or a peak rate fee.

In at least one embodiment the method for the provision of lumens to a customer may include regional considerations as well as residential considerations in pricing as related to the simultaneous provision of lumens as illumination and pulsed light communications to a customer.

In addition, in at least one embodiment a particular room within a residential structure may include a controller having an awareness of location and function within an overall structure lighting and communication system. In at least one embodiment a controller or control server will calculate lumen generation, pulsed light communications, or consumption, and compensation for the lumen generation/consumption.

In some embodiments, the calculation will include an assessment of variables which may be present for an LED light which may vary in intensity, vary in proficiency level, vary in degradation, vary in color such as LED's produced in yellow which are less efficient as compared to LED's produced in white, where these and other variables are interrogated or received by the controller or control server. In some embodiments, the control server has the capability to send a signal/instruction back (or upstream) to the controller in communication with a particular light fixture, in order to adjust the LED light fixture, to alter the level of electricity to be provided to the LED light fixture, to modify or enhance lumen output, or regulate performance.

In turn, in some embodiments the control server will calculate the previous lumen generation/consumption and the adjusted lumen generation/consumption for inclusion within client invoices to be paid by the customer to the lumen provider. In some embodiments compensation for an amount of electricity is paid to the electrical provider by the lumen provider on behalf of the customer. In some embodiments the customer receives invoices for the generation of data lumen hours, data lumen minutes, or some other quantity of lumen consumption/generation where data lumen hours or minutes includes usage of light for illumination and/or data or information transfer or communication.

In some embodiments lumen hour production may be calculated by metering or net metering of either light or electricity. In some embodiments the calculation for compensation for data lumen hour consumption may include calculations derived from metering, net metering and multipliers associated with the variables as identified herein, and/or other variables which affect lumen and pulsed light communication output such as the volume data usage.

In some embodiments, a fixture controller may include a meter or a supplemental meter to record lumen generation and/or pulsed light communication data usage at an LED light fixture. In some embodiments a supplemental meter may be used between a fixture controller; a facility controller; and/or a controller server on a structure to minimize or to eliminate the necessity to rewire an existing structure. In some embodiments a supplemental meter which may include a supplemental recorder my accumulate data from a plurality of LED light fixtures and/or fixture controllers within a structure.

In at least one embodiment, the control server includes data tables and algorithms which process received recorded data from the fixture controllers and/or the facility controllers which are used to generate a return signal to the facility controllers and the fixture controllers to adjust electrical input into the LED light sources to optimize the generation of lumens and pulsed light data communications.

In at least one embodiment the stored data within the data tables and algorithms will be directed to optimization of variables as identified herein some of which being color; intensity levels, degradation as a result of time or use; historic usage as well as other variables. In addition, the control server includes data tables and billing algorithms which are used to process data and information received from the fixture controllers and/or the facility controllers to generate and calculate the data lumen hours and/or data lumens per minute utilized at a facility, and to generate a periodic customer invoice for the customers consumption of the data lumen hours, data lumen minutes, data usage, and/or illumination usage at a particular LED light fixture or facility or other designated geographic area or location.

An algorithm may be utilized to calculate and to translate usage into data lumens per hour or data lumens per minute for billing purposes to a client. In some embodiments, the dongle or key device may be utilized to provide conference communications between one or more other individuals through pulsed light communications or converted communications as described herein.

The controller, website, and/or interface enable the selection or customization of programs for individual areas or rooms or individual groups of lights or specific lights over a cubicle or other location. All of the information related to wattage used may be collected on the power unit controller. A server may be set up at a remote location that will retrieve power/wattage usage information from the power unit controller, and enter the information into one or more servers, where the information is communicated to and processed by a billing system for generation of bills to users of the LED light fixtures, for consumption of illumination, pulsed light communications, data lumens per hour, or data lumens per minute or other measurement unit.

The LED lights change intensity, turn on and off, and change color. Each of those factors use a different amount of electricity and produce different data which may be characterized as a data lumen hour.

In one embodiment, the invention is directed to the sale-resale of light and how the light is sold. In at least one alternative embodiment, the invention is directed to how the sale or resale of the light is calculated especially in circumstances in which a light will vary in intensity and/or has different efficiency levels depending on time of production and use. In some embodiments, yellow colored LED's are less efficient than white LEDs. In at least one embodiment, all of these different factors and variations are calculated through the use of software on a controller or a microcontroller which is ultimately being interrogated by a computer/server to process the data related to the variables, and to generate calculated sums to be used in billing algorithms or processing on a billing computer. In at least one embodiment, the computer/server calculates the data lumen hours, and/or data lumen minutes or other periodic measurement unit. Calculation of variables includes power consumption, LED rating and color, LED age and light degradation and the provision of variable power to the LED's. It should be noted that many more variables may also be present. In at least one embodiment of the invention, data lumen hours are produced and metered and sold.

In at least one embodiment, sub-meters may be used to measure electricity or lumens at a light fixture. Information of data lumen generation/consumption from each light fixture may be accumulated and communicated to a control server for processing and generation of an invoice to a customer regardless as to the external or internal source of electricity provided to the individual LED light fixtures.

In at least one embodiment, each LED light fixture may include a light sensor which may be used to record illumination from an LED light fixture which in turn may be used to calculate data lumen hours.

The use of electricity from an electrical source to produce photons of light may initiate from an external source such as a power company or an internal source which in one embodiment may be a wind turbine or other electricity generating source.

In at least one embodiment, a customer of the light photons will be responsible to provide compensation for and/or instillation of the LED light panels or fixtures. In one alternative embodiment, the calculation of a data lumen hour may occur through metering. In at least one alternative embodiment, the expense for a data lumen hour may vary depending on geography. In at least one alternative embodiment, the method to provide data lumen hours will occur through taking over a customer's entire power bill with an electrical provider.

In an alternative embodiment, the method to provide data lumen hours will occur through use of an outboard meter in electrical communication with the LED light panels, and communication to a power company of data from a sub-meter for the calculated data lumen hours as a second invoice, so a client will receive a payment derived for general use of electricity, and electricity for specific use in generation of data lumen hours as processed within the server. In this embodiment, the electricity provider would need to accept the data/information from the sub-meter for billing to an electrical consumer.

In at least one embodiment, a separate and distinct data lumen hour meter will be interfaced onto a discrete circuit for the LED light panels.

In at least one embodiment, it is difficult to use a meter or sub-meter and to chase or track existing wiring through the building to a discriminating box in order to use a meter or sub-meter to measure data lumen hours. In at least one embodiment, a supplemental or sub-meter is in electrical communication with each LED light panel fixture. Data recorded at each supplemental or sub-meter may be assimilated and combined to formulate and calculate data lumen hour usage and an amount of compensation to paid for the data lumen hour consumption.

In at least one embodiment, in existing construction, a large centralized switch may be provided having a meter, and a plurality of sub-meters may be electrically connected and in communication with the centralized switch, where each sub-meter may measure data for calculation of data lumen per hour consumption.

In at least one embodiment, a sub-meter is positioned proximate to an LED light panel. In other embodiments, a sub-meter may be at a distance removed from an LED light panel. In some embodiments, a sub-meter may be electrically connected upstream and/or downstream, from each LED light panel and either one or both of the sub-meters may be proximate to, or spatially removed from an LED light panel, in any combination without restriction.

In at least one embodiment, a sub-metering function may be utilized on a per LED light basis, within each LED light panel, and in other embodiments, the data collection function may be incorporated as a feature of a “smart LED” used in an LED light panel. In at least one embodiment, a digital potentiometer may be used with each LED light panel.

In some embodiments, a data lumen hour may have different values dependent on variables such as the color of the LED's, age of the LED's; output of the LED's to name a few.

In some embodiments, metering may occur through interruption of a switch which may be electrical or mechanical, going to the ground, or based on load.

In at least one embodiment, a meter or sub-meter collects data concerning electrical consumption before and after an LED light panel in a manner similar to the measurement of electrical resistance across the LED light panel, and a calculation will occur because a certain amount of electrons will be converted to photons. In other embodiments, a meter or sub-meter may include a light sensor with a meter to measure light output.

In some embodiments, variables used in calculation of data lumen hours or minutes include varying illumination intensity, varying LED light intensity, the color of the LED's, the frequency of the duty cycle for the LED's during operation; the periods of time that the LED's are on or off; the frequency service; the electricity provided to the LED's; the adjusted electricity provided to the LED's, the type of LED's; the manufacturer or the LED's and the volume of data communicated through the LED's to name a few. These and other variables when considered and summarized yield a different amount of data lumen hours/minutes for individual LED's as well as LED light fixtures.

In some embodiments, the calculation of data lumen hours may also include an initial activation fee which may be invoiced separately or financed into the expense of a data lumen hour.

In some embodiments, a facility may have two or more electrical meters. A first electrical meter will be a meter from an electrical provider such as a power company or other electrical source. A secured meter will be a meter for illumination and data lumens per hour or minute. The second meter would transit the accumulated information and data concerning data lumen hours to the control server for processing to calculate compensation due from a customer for the usage of the data lumen hours for illumination and data communication.

In some embodiments, a room may include any number of LED light fixtures. Each LED light fixture may be operating the same, or have a different setting resulting in different operation. In at least one embodiment, the data lumen hours or minutes for each LED light fixture may be recorded or regulated independently with respect to any other LED light fixture. A composite amount of data lumen hours or minutes may be calculated from the independent LED light fixtures and communicated to a facility controller or a control server.

In some embodiments, the frequency of electricity, voltage, current, and values representing the intensity of each string of LED lights is being recorded every second. In some embodiments, a light fixture has a maximum of 161 lights, each with a Cool White and a Warm White string.

This application also incorporates by reference in their enteritis U.S. patent application entitled “LED Light Control and Management System,” filed contemporaneously herewith, having internal file number 15890-US05; U.S. patent application entitled “Pulsed Light Communication Key,” filed contemporaneously herewith, having internal file number 15890-US04; and U.S. patent application entitled “LED Light Fixture,” filed contemporaneously herewith, having internal file number 15890-US03.

Applicant incorporates by reference in this application U.S. Pat. Nos. 6,879,263, 7,046,160, 7,439,847, 7,902,978, 8,188,861, 8,188,878, 8,188,879, 8,330,599, 8,331,790, 8,542,096, 8,543,505, 8,571,411, 8,593,299, U.S. application Ser. Nos. 12/126,227, 12/750,796, 13/427,358, 13/479,556, 13/706,864, 13/972,294, 14/033,014, 14/050,759, 14/050,765, and U.S. Provisional Application Ser. Nos. 61/778,672, 61/783,501, 61/819,861, 61/867,731, 61/927,638, 61/927,663 in their entireties.

Various aspects of the disclosure have been described. These and other aspects are within the scope of the following claims.

The present invention may be embodied in other specific forms without departing from the spirit or essential attributes thereof; and it is, therefore, desired that the present embodiment be considered in all respects as illustrative and not restrictive, reference being made to the appended claims rather than to the foregoing description to indicate the scope of the invention.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

In addition to being directed to the embodiments described above and claimed below, the present invention is further directed to embodiments having different combinations of the features described above and claimed below. As such, the invention is also directed to other embodiments having any other possible combination of the dependent features claimed below.

This completes the description of the preferred and alternate embodiments of the invention. Those skilled in the art may recognize other equivalents to the specific embodiment described herein which equivalents are intended to be encompassed by the claims attached hereto.

1. (canceled)

2. The method of claim 9, further comprising communicating the amount of electricity to a computing device on a weekly basis.

3. (canceled)

4. The method of claim 9, wherein the identifier comprises global positioning system information.

5. The method of claim 9, further comprising communicating the amount of electricity to the computing device upon a user or provider request.

6. The method of claim 9, further comprising:
identifying the total amount of electricity associated with each respective light emitting diode light fixture, and the amount of data lumen hours or data lumen minutes generated by the at least one light emitting diode light fixture over a period of time.

7. The method of claim 6, further comprising:
automatically increasing an amount of current applied to at least one light emitting diode of the at least one light emitting diode light fixture if the amount of lumens generated by the at least one light emitting diode light fixture is determined to be below a pre-determined level.

8. The method of claim 9, further comprising calculating data lumen hours or data lumen minutes for each of the at least one light emitting diode light fixtures for the period of time and comparing the calculated data lumen hours or data lumen minutes to data representative of a desired level of data lumen hours or data lumen minutes wherein the at least one processor automatically adjusts electricity to be provided to each of the at least one light emitting diode light fixture to achieve the desired data lumen hours or data lumen minutes.

9. A method of generating lumens from at least one light emitting diode light fixture, the method comprising:
providing at least one light emitting diode light fixture, generating photons of light for a period of time, said photons of light comprising information or data;
using a meter to record the electricity entering the at least one light emitting diode light fixture over the period of time and storing the metered amount of electricity entering the at least one light emitting diode light fixture over the period of time in memory on at least one processor;
measuring the photons of light exiting the at least one light emitting diode light fixture over the period of time and storing in said memory the measured photons of light exiting the at least one light emitting diode light fixture over the period of time on the at least one processor;
comparing at the at least one processor the measured amount of photons of light at each of the at least one light emitting diode light fixture for the period of time to data representative of a desired lumen emission level wherein the at least one processor automatically adjusts the electricity to be provided to each of the at least one light emitting diode light fixture to achieve the desired lumen emission level;
storing in said memory the adjusted electricity provided to each of the at least one light emitting diode light fixture for the period of time;
retrieving from memory and compiling on a computing device the metered electricity and the adjusted electricity provided to each of the at least one light emitting diode light fixture for the period of time; and
recording in the memory the compiled metered electricity and the adjusted electricity for the period of time and assigning a light emitting diode light fixture identifier to the compiled metered electricity and the adjusted electricity.
